(19) United States
(12) Patent Application Publication
(10) Pub. No.: US 2008/0218808 A1
(43) Pub. Date: Sep. 11, 2008

(54) Method and System For Universal File Types in a Document Review System

(75) Inventor: Willem R. Van Den Berge, El Paso, TX (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: ALTEP, INC., El Paso, TX (US)

(21) Appl. No.: 12/038,802

(22) Filed: Feb. 27, 2008

Related U.S. Application Data
(60) Provisional application No. 60/893,616, filed on Mar. 7, 2007.
(60) Provisional application No. 60/893,613, filed on Mar. 7, 2007.

(51) Int. Cl. H04N 1/00

(52) U.S. Cl. 358/403

(57) ABSTRACT

A system, method and machine-readable medium providing for review of documents. The method includes receiving a request for a document over a network from a document presentation device, the document having a file type; retrieving the document from a memory; determining the file type; in response to determining the file type is in one of a first set of formats, sending the document to the document presentation device; and in response to determining the file type is in one of a second set of formats, launching an application on a remote application server and sending information to the document presentation device to display the output of the application on the document presentation device, the application corresponding to the file type.

### CROSS-REFERENCE TO RELATED APPLICATIONS

This application claims benefit and priority under 35 U.S.C. §119(e) of the following co-pending provisional applications having at least one common inventor with this application: Ser. No. 60/893,613, filed Mar. 7, 2007, entitled “Method and System for Universal File Types in a Document Review System”; Ser. No. 60/893,616, filed Mar. 7, 2007, entitled “Method and System for Rules Based Tag Management in a Document Review System”. The entire disclosures of the above applications are incorporated herein by reference.

The entire disclosure of commonly-assigned co-pending application Ser. No. not yet assigned, attorney docket no. 101915-200101/US, entitled “Method and System for Rules Based Tag Management in a Document Review System,” by inventor Willem van de Berge, filed the same day as this application, is incorporated herein by reference.

The entire disclosure of commonly-assigned co-pending application Ser. No. not yet assigned, attorney docket no. 101915-200201/US, entitled “Method and System for Document Searching,” by inventor David A. Morales, filed the same day as this application, is incorporated herein by reference.

The entire disclosure of commonly-assigned co-pending application Ser. No. not yet assigned, attorney docket no. 101915-200301/US, entitled “Method and System for Searching and Generating To Do List,” by inventor David A. Morales, filed the same day as this application, is incorporated herein by reference.

The entire disclosure of commonly-assigned co-pending application Ser. No. not yet assigned, attorney docket no. 101915-200501/US, entitled “Method and System for Hierarchical Document Management in a Document Review System,” by inventor David A. Morales, filed the same day as this application, is incorporated herein by reference.

### TECHNICAL FIELD

This invention relates generally to the field of document review systems. More particularly, the invention relates to a method and apparatus for managing documents in multiple formats in a document review system.

### BACKGROUND

Document review systems are employed to search for specific words or phrases within a set of documents and identify documents that meet specified criteria with a common identifiers, such as tags.

Document review systems are used for managing the document review in the discovery phase of litigation. Some systems perform native document review in which the documents requested are retrieved from the server computer system and opened on the server computer in the same application that was used to create the original document. A remote access system is used to allow the user to view the document exactly as it would be on the client's system. However, the same documents may have been converted to images, redacted, or annotated in a previous document review project or case. What is needed is an ability to access native documents while also having access to converted, redacted or annotated views of the same documents.

### BRIEF SUMMARY

A system, method and machine-readable medium providing for review of documents. The method includes receiving a request for a document over a network from a document presentation device, the document having a file type; retrieving the document from a memory; determining the file type; in response to determining the file type is in one of a first set of formats, sending the document to the document presentation device; and in response to determining the file type is in one of a second set of formats, launching an application on a remote application server and sending information to the document presentation device to display the output of the application on the document presentation device, the application corresponding to the file type.

### BRIEF DESCRIPTION OF THE DRAWINGS

These and other features, aspects, and advantages will become better understood with regard to the following description, appended claims, and accompanying drawings where:

FIG. 1 illustrates a block diagram of one embodiment of a system.

FIG. 2 illustrates one embodiment of a flow diagram of a process of retrieving and displaying documents.

FIG. 3 illustrates a one embodiment of a representation of a screen image of a native document.

FIG. 4 illustrates a one embodiment of a representation of a screen image of a tagged image format (TIF) document.

FIG. 5 shows a system having a machine-readable medium to store a set of instructions to perform a process according to one embodiment.

### DETAILED DESCRIPTION

At least some embodiments of the disclosure relate to a method and apparatus for managing projects.

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but are not necessarily, references to the same embodiment, and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

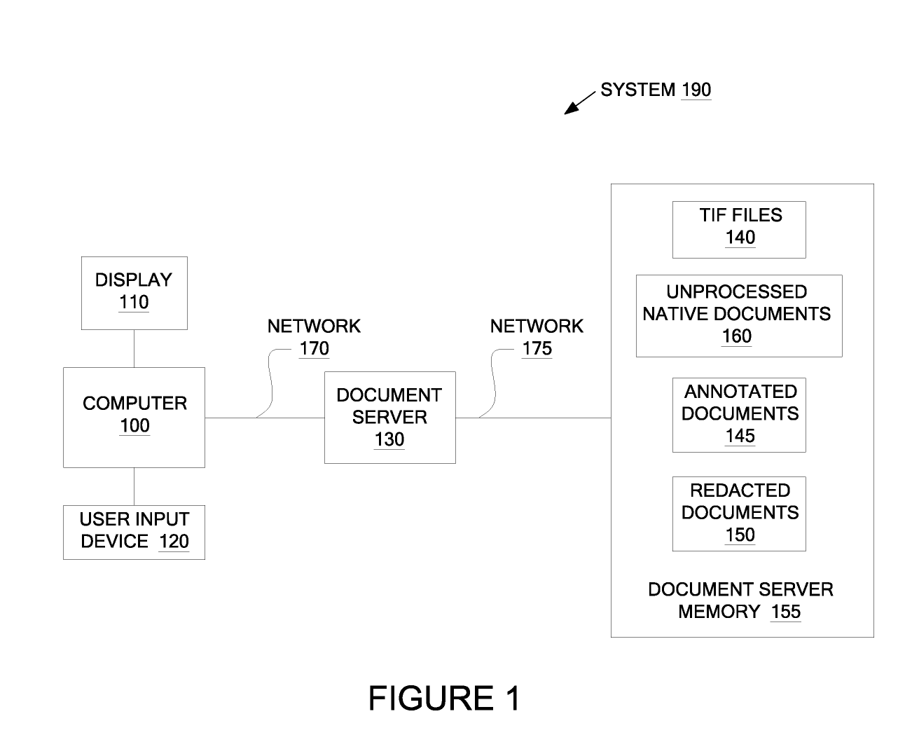

FIG. 1 illustrates one embodiment of a system. A system 190 includes a computer 100 coupled to a user-input device 120 and a display 110. The computer 100 is coupled through a network 170 to communicate with a document server 130. The document server 130 is coupled to access documents stored in a document server memory 155. In one embodiment, the system is used for document review during the discovery phase of litigation. In other embodiments, the system 190 is used in other document review applications.

In one embodiment, the computer 100 receives a request for a document through the user-input device 120 and requests the document from the document server 130. The computer 100 displays the document on the display 110.

The user-input device 120 may be a keyboard, mouse, a voice recognition device, of some other device used to receive input from a user. In some embodiments, the user-input device 120 includes more than one means to receive user input, such as keyboard and mouse. The display 110 may be a computer monitor or any other device used to present output of a computer.

The document server 130 is coupled through a network 175 to a document server memory 155 storing tagged image format (TIF) files 140, unprocessed native documents 160, annotated documents 145 and redacted documents 150. In one embodiment, the TIF files 140 include scanned documents from the client archives. Unprocessed native documents 160 are document files that are not modified since they were secured for the purpose of litigation, for example. Common file formats include Microsoft Word, Microsoft Excel and Microsoft PowerPoint files. But it will be apparent to one skilled in the art that the unprocessed native documents 160 may be in any file format. In one embodiment, these applications and their configurations are not modified since they were secured for the purpose of litigation so that the display of the documents are not changed by application software or configuration changes.

In some cases, the annotated documents 145 include annotations that were made when a corresponding image of the original document was viewed for a previous case or project. Unprocessed native documents 160 are not annotated. In some cases, redacted documents 150 include redactions that were made for a previous case or project. In some embodiments, annotated documents 145 and redacted documents 150 are stored as TIF files.

The document server 130 can be one or more clusters of computers. In some embodiments, the document server 130 includes one or more web servers to interface with the network 175 and the network 175 is an internet or intranet. In some embodiments, the document server 130 includes one or more computers to manage the storage and retrieval of documents and to interface with a web server or directly with a client computer to present an image of the document.

The document storage memory 155 can include local memory such as dynamic random access memory or a local hard disk accessed over a local bus on the document server 130 and/or remote memory accessed over an intranet to one or more database servers or other networked storage, for example.

In some embodiments, the network 175 is a local bus in the document server 130 and the document server memory 155 is a hard disk drive or other local memory in the document server 130. In other embodiments, the network 175 is an intranet and the documents server memory 155 is a networked storage system. In yet other embodiments, the network 175 is the internet and the document server memory 155 is a memory on a remote computer system coupled to a web server to provide requested documents to the document server 130.

In some embodiments, documents are retrieved directly over the internet from the computers on which they were originally stored, such as a client's computer systems. In other embodiments, the document server memory 155 stores a copy of the documents secured to ensure that the state of the documents is preserved for the purpose of litigation, for example. Storing a copy of the documents also can ensure that the documents are available for search independent of accessibility of the client's computer system.

When the document server 130 receives a request for a document, it determines the file type by examining the file type extension and/or meta data. If the document is a TIF, the document server 135 transmits a representation of the TIF file to the computer 100, where it is displayed. In one embodiment, the TIF file is displayed by a TIF-viewer plug-in installed in a browser on the computer 100.

In some cases, the document server 130 includes one or more remote access application servers, such as Citrix servers, used to remotely view applications running on the document server 130. If the document server 130 determines that the document is not in a TIF format but a format supported by the remote access application server, the document server 130 retrieves a copy of the document from the document server memory 155 and passes the document to a remote access application server. The remote access application server runs an application corresponding to the document format and transmits images of the output of the application to the computer 100 through an application viewer on the computer 100. The remote access application server receives user-input from the computer 100 to control the application on the remote access application server in much the same way as the application would be controlled if it were run locally on the computer 100.

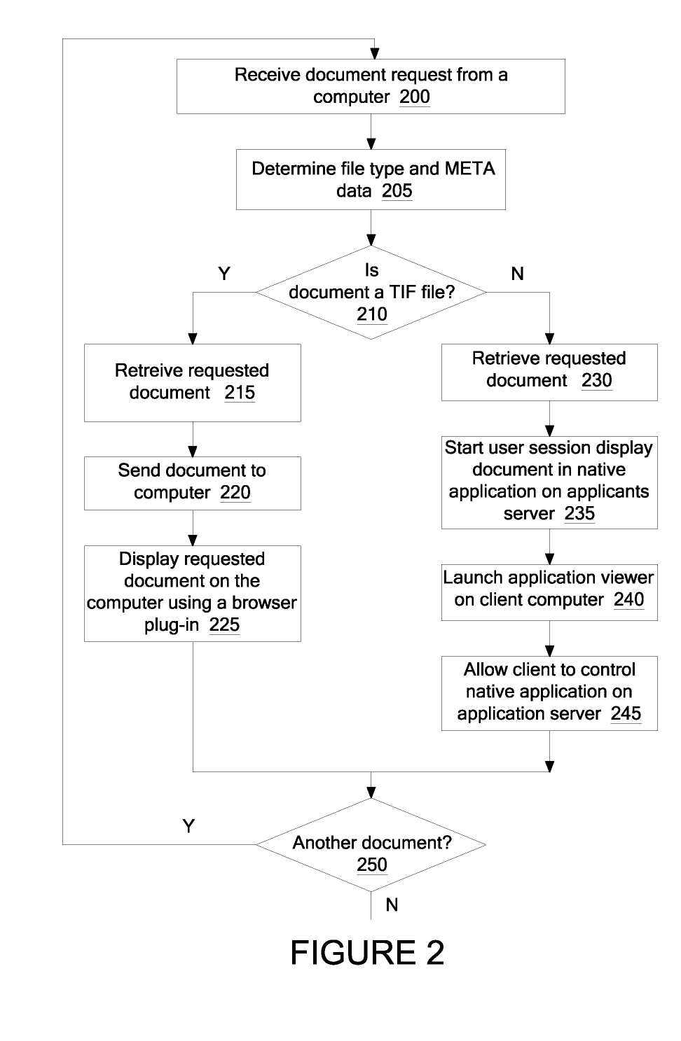

FIG. 2 is a flow diagram of a method and is described in conjunction with FIG. 1 and FIGS. 3 and 4 representing screen images in one embodiment.

In process 200, the document server 130 receives a request for a document from the computer 100 via the network 170. In process 205, the document server 130 determines the file type and meta data for the document. In one embodiment, the file type and meta data can be used to determine which application is needed to process the document.

In process 210, the document server 130 determines whether the requested document is a TIF file. If the requested document is a TIF file, process 215 is performed. If the requested document is not a TIF file, process 230 is performed.

In process 215, the document server 130 retrieves the requested document from a document server memory 155.

In process 220, the requested document is sent to the computer 100 over the network 170.

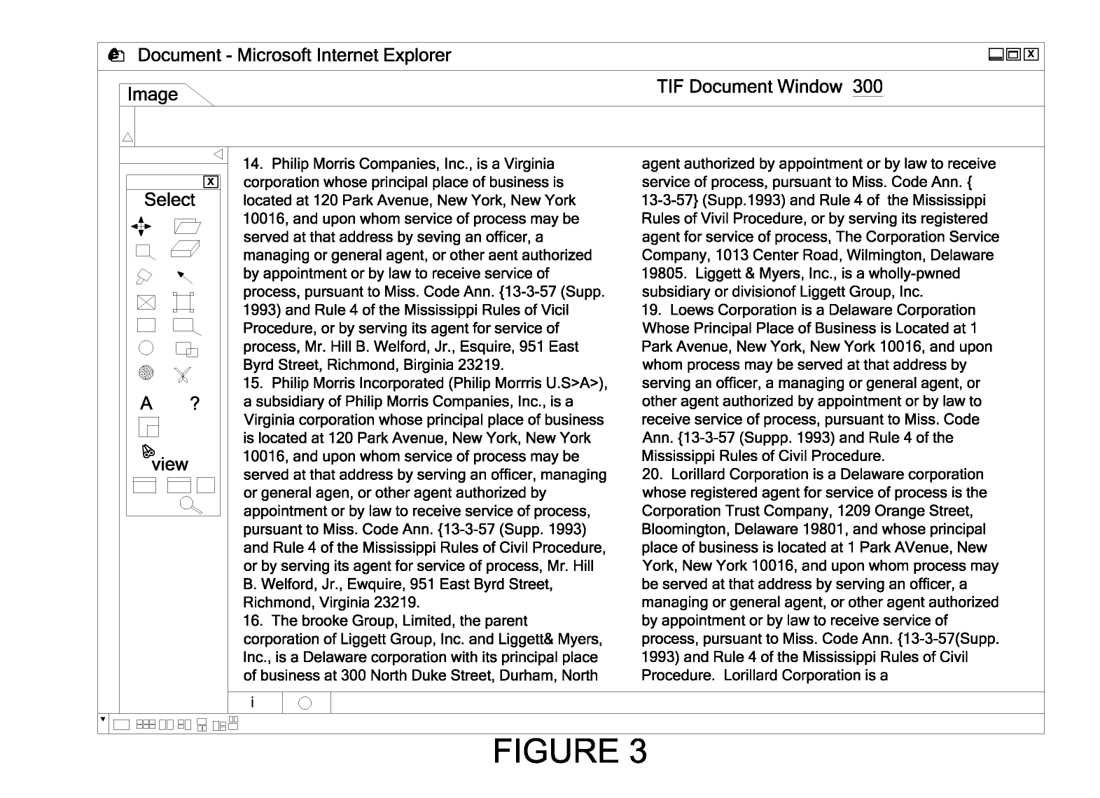

In process 225, the requested document is displayed on the display 110 of the computer 100. FIG. 3 shows a screen image of a display in one embodiment of a TIF viewer display. In one embodiment, the document is displayed using a TIF viewer available in the browser on the computer 100. The TIF document window 300 displays a portion of the TIF document. In one embodiment, the TIF viewer document window 300 displays different portions of the document window.

In process 230, the requested documents are retrieved by the document server.

In process 235, the user session is started and the document is launched in native application format on a remote application server. The remote application server launches an application corresponding to the file type and/or meta data of the requested document. For example, if the file extension is .doc, a Microsoft Word application is launched. And if the file type is .xls, a Microsoft Excel application is launched.

In process 240, an application viewer is launched on the client computer. Since the application is launched on the remote application server and not the computer 100, the computer 100 does not need to have these applications installed and application licensing fees for the computer 100 are avoided.

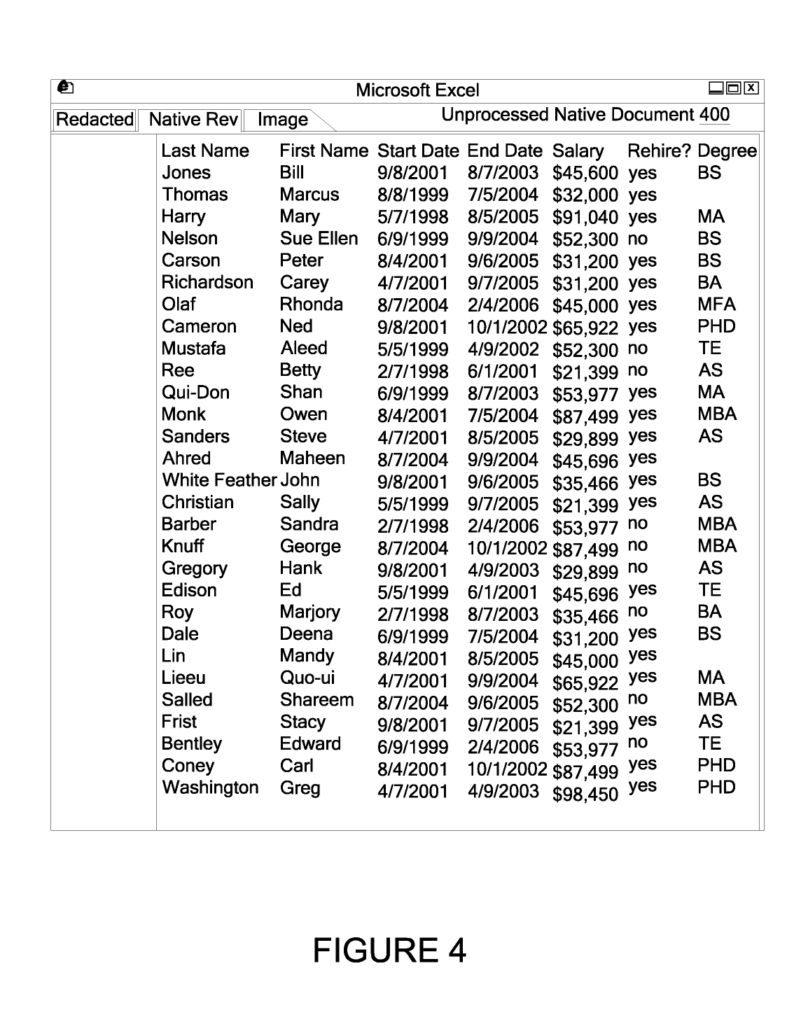

In process 245, the computer 100 controls the application on the remote application server. The user is able to use the computer 100 to control the native application on the application server. FIG. 4 shows a screen image of a display in one embodiment of an unprocessed native document display. In one embodiment, the document server 130 sends an web page representing the display of the launched application. In another embodiment a TIF or other representation of the display of the launched application is sent by the document server 130.

In process 250, it is determined whether another document is requested. If yes, process 200 is performed. Otherwise the process is completed.

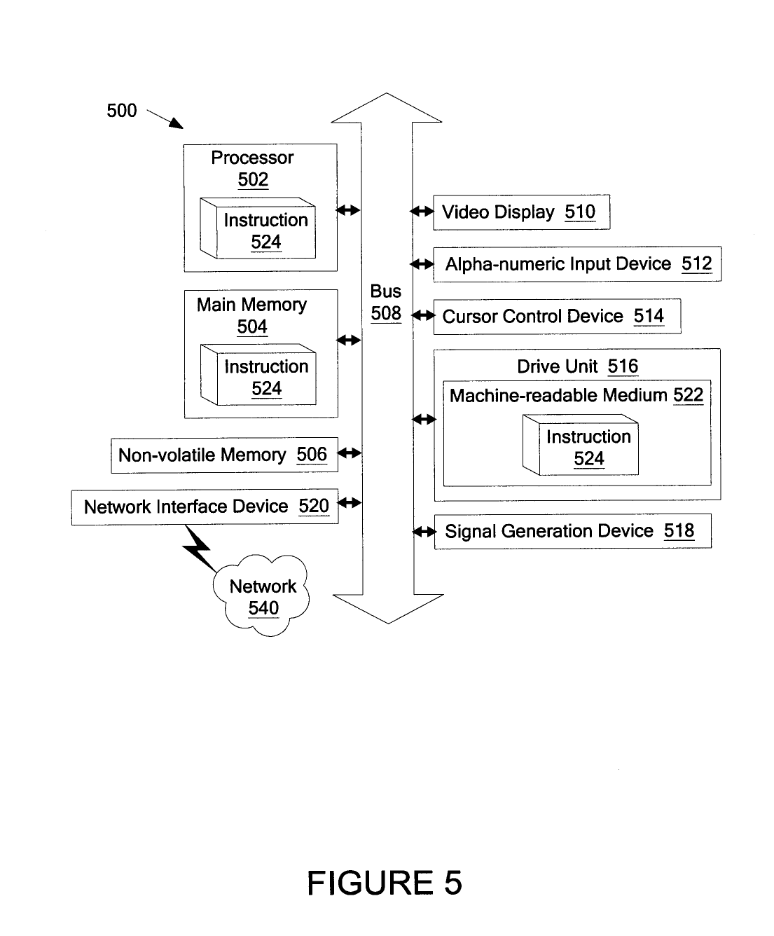

FIG. 5 shows a diagrammatic representation of a machine in the exemplary form of a computer system 500 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment. In one embodiment, the machine communicates with the server to facilitate operations of the server and/or to access the operations of the server.

The computer system 500 includes a processor 502 (e.g., a central processing unit (CPU) a graphics processing unit (GPU) or both), a main memory 504 and a nonvolatile memory 506, which communicate with each other via a bus 508. In some embodiments, the computer system 500 may be a laptop computer, personal digital assistant (PDA) or mobile phone, for example. The computer system 500 may further include a video display unit 510 (e.g., a liquid crystal display (LCD) or a cathode ray tube (CRT)). The computer system 500 also includes an alphanumeric input device 512 (e.g., a keyboard), a cursor control device 514 (e.g., a mouse), a disk drive unit 516, a signal generation device 518 (e.g., a speaker) and a network interface device 520. The disk drive unit 516 includes a machine-readable medium 522 on which is stored one or more sets of instructions (e.g., software 524) embodying any one or more of the methodologies or functions described herein. The software 524 may also reside, completely or at least partially, within the main memory 504 and/or within the processor 502 during execution thereof by the computer system 500, the main memory 504 and the processor 502 also constituting machine-readable media. The software 524 may further be transmitted or received over a network 540 via the network interface device 520.

While the machine-readable medium 522 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies described herein. The term “machine-readable medium” shall accordingly be taken to include, but not be limited to, solid-state memories, optical and magnetic media, and carrier wave signals.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Although embodiments have been described with reference to specific exemplary embodiments, it will be evident that the various modification and changes can be made to these embodiments. Accordingly, the specification and drawings are to be regarded in an illustrative sense rather than in a restrictive sense. The foregoing specification provides a description with reference to specific exemplary embodiments. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A system comprising:
a document presentation device configured to interface with a remote application server;
a document server configured to receive a request for a document from the document presentation device over a network, the server being configured to retrieve the requested document from a memory, determine the file type of the requested document, and if the file type is one of a first set of formats, send the file to the computer to be displayed and if the file type is one of a second set of formats, launch an application corresponding to the file type and send information over the network to the document presentation device to display the document on the document presentation device.

2. The system of claim 1 wherein the first set of formats comprises a tagged image format.

3. The system of claim 2 wherein the computer comprises a browser, the browser being configured to display documents in the tagged image format.

4. The system of claim 2 wherein the document is an annotated document.

5. The system of claim 2 wherein the document is a redacted document.

6. The system of claim 1 wherein the document server comprises a remote application server configured to launch an application corresponding to the file type and send information over the network to the document presentation device to display the document on the document presentation device.

7. A method comprising:
receiving a request for a document over a network from a document presentation device, the document having a file type;
retrieving the document from a memory;
determining the file type; and
in response to determining the file type is in one of a first set of formats, sending the document to the document presentation device; and
in response to determining the file type is in one of a second set of formats, launching an application on a remote application server and sending information to the document presentation device to display the output of the application on the document presentation device, the application corresponding to the file type.

8. The method of claim 7 wherein the first set of formats comprises a tagged image format.

9. The method of claim 8 wherein the tagged image format file is displayed using a browser.

10. The method of claim 8 wherein the document is an annotated document.

11. The method of claim 8 wherein the document is a redacted document.

12. The method of claim 1 further comprising using the information to generate the display on the document presentation device.

13. A machine-readable medium that provides instructions for a processor, which when executed by the processor cause the processor to perform a method comprising:
receiving a request for a document over a network from a document presentation device, the document having a file type;
retrieving the document from a memory;
determining the file type; and
in response to determining the file type is in one of a first set of formats, retrieving and sending the document to the document presentation device; and
in response to determining the file type is in one of a second set of formats, launching an application on a remote application server, and sending information to the document presentation device to display the output of the application on the document presentation device, the application corresponding to the file type.

14. The machine-readable medium of claim 13 wherein the first set of formats comprises a tagged image format.

15. The machine-readable medium of claim 14 wherein the document is displayed using a browser.

16. The machine-readable medium of claim 14 wherein the document is an annotated document.

17. The machine-readable medium of claim 14 wherein the document is a redacted document.

18. The machine-readable medium of claim 13 further comprising using the information to generate the display on the document presentation device.
